(19) United States
(12) Patent Application Publication
(10) Pub. No.: US 2010/0306067 A1
(43) Pub. Date: Dec. 2, 2010

(54) AUTOMATED SELL SYSTEM

(76) Inventors: Richard Hui, Coquitlam (CA); John Almond, West Vancouver (CA)

Correspondence Address: DOWELL & DOWELL P.C., 103 Oronoco St., Suite 220, Alexandria, VA, 22314, US

(21) Appl. No.: 12/791,651

(22) Filed: Jun. 1, 2010

Related U.S. Application Data
(60) Provisional application No. 61/182,707, filed on May 30, 2009.

(51) Int. Cl. G06Q 30/00

(52) U.S. Cl. 705/14.73; 705/26

(57) ABSTRACT

An automated sell system comprises a hardware device for inputting product information onto a server. A network allows a user to access the product information together with a means for generating a coded file of the product information for use as an advertisement on a website. Preferably the advertisement is presented in accordance with appropriate marketing practices. In one embodiment, the means for generating the coded file is run by a single command.

### BACKGROUND OF THE INVENTION

1. Field of the Invention

The present invention relates to an automated sell system. Particularly the present invention relates to an automated sell system which allows a user to list a good or service for sale on a third party website.

2. Description of the Related Art

There is often a desire to sell goods which are presently owned but no longer used. The goods may be consumer items such as cars, televisions, other electronics, or household items which are often sought by price conscience consumers; or the goods may be office equipment or office furnishings which are often sought by start-up or small businesses. There is also often a desire to sell third party services which have either been contracted for or paid for but, are either no longer being used or will not be used. For example, previously purchased tickets or other transferable service contracts may be sold by individual consumers or businesses.

Market research has shown that a seller should provide a detailed description of a good or service being sold when presenting the product for sale. This facilitates the sale in a valued manner. Accordingly, when organizing the sale of products, significant time and effort is often spent collecting product information to effectively present the product to a potential buyer. Product descriptions, images thereof, and manuals therefor, etc. are all gathered to facilitate an effective sale at a maximized sale price. Most sellers typically collect product information by surfing the World Wide Web and downloading relevant content. However, sellers are often not able to obtain sufficient information to provide a detailed description of the product and, in particular, to provide a detailed description of an individual product including date of first purchase, repair history, etc. Furthermore, due to the effort involved, some sellers simply present the product for sale without a detailed description of the product. This may result in a less than optimum sales result.

Some current online resale websites allow users to view information on products they have purchased in the past. This allows the user to readily collect product information when presenting the product for resale. However, the available information is generally limited and resale may be restricted to a specific website. In some cases the information is even purged after a specified period of time. For example, in the ticket industry, some websites allow the resale of tickets with minimal effort but they do not allow resale on other websites or allow a user to generate a full description of the event for which the ticket is being sold. These websites leave it to the user to create online advertisements for the resale of the ticket. This may result in the user spending a significant amount of time locating information on the event, and the ticket often being sold with less information on the event than may be available. Furthermore, effective marketing strategies related to type, text, and layout are often not considered or even within the skill set of the user. This can result in poorly designed advertisements yielding less then optimal sales results.

There is accordingly a need for an improved automated selling system.

### SUMMARY OF THE INVENTION

It is an object of the present invention to provide to an automated sell system which allows a user to list a good or service for sale on a third party website.

It is a further object of the present invention to provide an automated sell system which allows a user to list a good or service for sale on a third party website together with all available product information.

It is still a further object of the present invention to provide an automated sell system which allows a user to list a good or service for sale on a third party website in accordance with appropriate marketing practices.

There is according provided an automated sell system comprising a hardware device for inputting product information onto a server. A network allows a user to access the product information together with a means for generating a coded file of the product information for use as an advertisement on a third party website. Alternatively, the coded file of the product information may be used as an advertisement on a website supported by the system. Preferably, the advertisement is presented in accordance with appropriate marketing practices. In one embodiment, the means for generating the coded file is run by a single command.

The automated sell system disclosed provides the advantage of allowing a user to maintain a central catalogue of products acquired from various locations. The catalogue includes product information including but not limited to: a general description of the product, the purchase price, the place, date and means of purchase, copies of sales receipts, a description of the manufacturer, the product name, the make and model number, specifications, data sheets, brochures, manuals, images of the product, copies of warranties, normal retail price, service history, and other details such as manufacturer or shipper policies. This reduces the time and effort required to effectively present a product for resale.

### BRIEF DESCRIPTION OF DRAWINGS

The invention will be more readily understood from the following description of preferred embodiments thereof given, by way of example only, with reference to the accompanying drawings, in which:

FIG. 1 is a block diagram showing an improved automated sell system.

### DESCRIPTION OF THE PREFERRED EMBODIMENTS

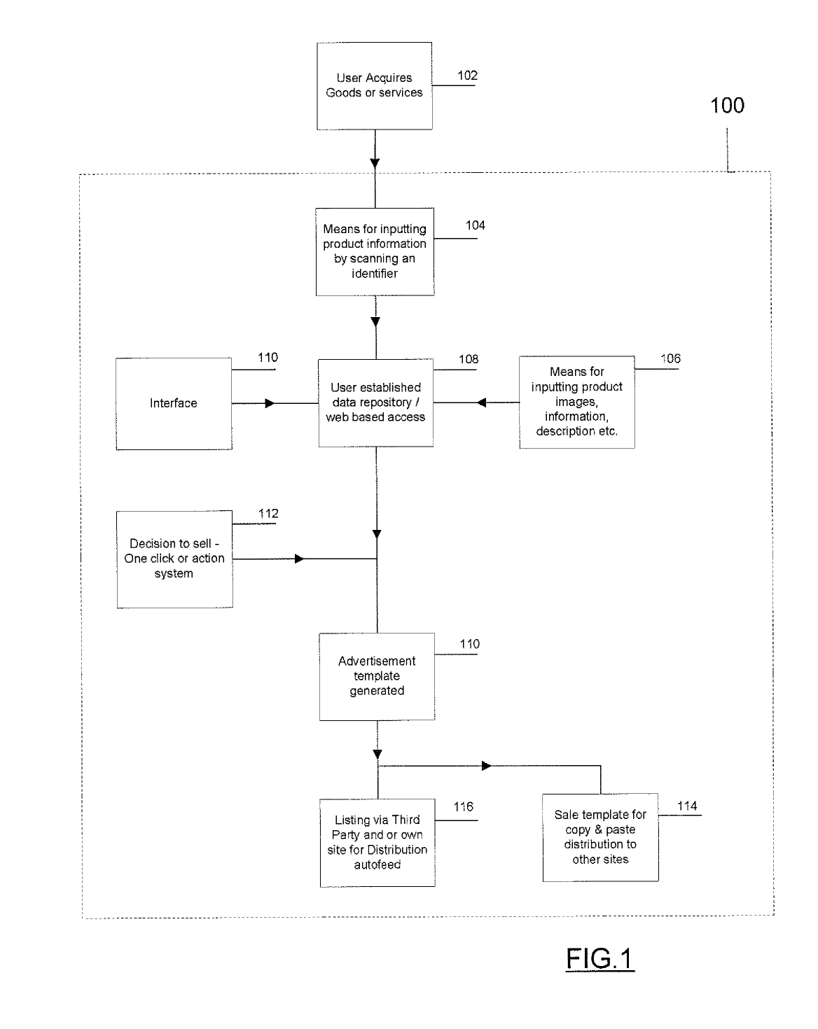

Referring to the drawings and first to FIG. 1 this is a block diagram showing an improved automated sell system 100, Each system user is identified by the system 100 using a unique identifier such as a username, password, and email. A system user may be any person or party who desires to resell a presently owned good or service which is either no longer being used or will not be used. Alternatively, a system user may be any person or party who may desire to resell an instantly acquired good or service, i.e. the good or service was acquired with the intention of reselling the same. It will be understood by a person skilled in the art that the term “user” as used herein is analogous with the terms “seller” and “vendor”. It will also be understood by a person skilled in the art that both goods and services are considered products. Accordingly, the term “product” as used herein may be either a good or a service.

After a user acquires a product as shown at block 102 the user may input product information into the system 100 as shown at blocks 104 and 106, The product may be acquired from a wholesale or retail store; at a garage sale, flea market, or private purchase; through an online purchase; or through a mail order. The product may be new or used and acquired from either an individual or a business. The product information may include, but is not limited to: a general description of the product, the purchase price, the place, date and means of purchase, copies of sales receipts, a description of the manufacturer, the product name, the make and model number, specifications, data sheets, brochures, manuals, images of the product, copies of warranties, normal retail price, service history and other details such as manufacturer or shipper policies.

In the example shown in FIG. 1, at least some of the product information is entered into the system 100 by scanning a UPC, SKU, RFID, or other appropriate identifier as shown at block 104. This will generate a permanent product record of the sale in a data repository which is shown at block 108. The data repository is available via web based access and may centric or non-centric in nature. The user may then add additional product information to the product record through image recognition or image capture technology and manual data entry as shown at block 106. The user may also update the product information in the product record through image recognition or image capture technology and manual data entry as shown at block 106. For example, it may be desirable to update the product record to reflect the fact that a car is receiving a regular tune-up.

In other examples, product information may be entered into the system using only image recognition or image capture technology and manual data entry at block 106. This may preferred when the product is acquired second hand and no product record exists in the system or where there is no electronic or radio identifier to allow product information to be scanned. In the case of an e-commerce acquisition, an automated feed through a unique identifier or email receipt may be sent to the system through a web based application during the acquisition. The system can accordingly receive information by point to point data transfer.

When the user desires to sell the product, the product record may be retrieved by accessing the data repository 108 via web based or mobile interface 110. Once the product record has been identified the user may generate an advertisement offering the product for sale with a single command as shown at block 112. The command may be a mouse click, a voice command, or a touch on a touch screen. The system 100 can then generate an advertisement, as shown at block 100, offering the product for sale in a number of ways. In this example, a HTML file, text file, or other suitable coded file may be generated for copying and pasting into resale websites such as Ebay®, Craigslist®, and Kijiji® as shown at block 114. Alternatively, the coded file may be for used in submissions broker firms, newspapers to run in the classifieds, or simply printed off and posted in the community. In other examples, the system 100 may generate a live sale page to a website, generate a live feed to partner websites, or generate a mobile component as shown at block 116. The generated feeds may include a data friendly file for import into other software programs. The process can be automated.

When the advertisement is generated it will be structured in accordance with appropriate marketing practices taking into account best practices in layout, text, search engine, key word friendly, and other features that will enhance the ability of the user to sell the product. The user can also decide to manually create the advertisement or choose from a number of templates. The system 100 will also allow the user to sell the product at a predetermined price or have the system 100 use an intelligent method to set a price based on the user's desire to sell quickly at a lower price or at market rates. Alternatively, the system 100 can provide the user with a list of comparable products so the user may decide on a predetermined price based on a comparison of past sales and current listing. When the product is sold it is either delisted from the system 100 or marked as SOLD. The system 100 may also allow for transfer of the product record together with product thereby allowing for continuous updating of the product record until the next resale.

In alternative embodiments, the system may be searchable, allowing a potential buyer to search for products based on various product record parameters. The search will generate a list of advertisements, each of which offers a product for sale within the parameters of the search. Access to these embodiments of the system may be via partnered resale website.

The automated sell system 100 disclosed herein provides the advantage of allowing a user to maintain a central catalogue of products acquired and owned from various locations. This reduces the time and effort required to effectively present a product for resale and is useful for an individual, family or business.

It will be understood by a person skilled in the art that many of the details provided above are by way of example only, and are not intended to limit the scope of the invention which is to be determined with reference to following claims.

What is claimed is:

1. An automated sell system comprising:
a hardware device for inputting product information;
a server for storing the product information;
a network for allowing a user to access the product information;
a means for generating a coded file of the product information for use as an advertisement.

2. The automated sell system of claim 1, wherein the means for generating the coded file is run by a single command.
